(19) United States
(12) Patent Application Publication
(10) Pub. No.: US 2015/0259568 A1
(43) Pub. Date: Sep. 17, 2015

(54) RADIATION-CURABLE AQUEOUS POLYURETHANE DISPERSIONS

(71) Applicant: BASF SE, Ludwigshafen (DE)

(72) Inventors: Reinhold Schwalm, Wachenheim (DE); Susanne Neumann, Speyer (DE); Peter Thury, Ludwigshafen (DE); Uwe Burkhardt, Ludwigshafen (DE); Sebastian Berger, Ann Arbor, MI (US); Sebastian Roller, Mannheim (DE)

(73) Assignee: BASF SE, Ludwigshafen (DE)

(21) Appl. No.: 14/439,045

(22) PCT Filed: Dec. 2, 2013
(86) PCT No.: PCT/EP2013/075268

§ 371 Date: Apr. 28, 2015

Related U.S. Application Data
(60) Provisional application No. 61/733,943, filed on Dec. 6, 2012.

(30) Foreign Application Priority Data
Dec. 6, 2012 (DE) 12195869.8

(51) Int. Cl. C09D 175/14; D21H 19/24; D21H 19/16; B05D 7/08; B05D 3/06

(52) U.S. Cl. CPC C09D 175/14; B05D 7/08; B05D 3/067; D21H 19/16; D21H 19/24

(57) ABSTRACT

The present invention relates to aqueous polyurethane dispersions that are curable with UV radiation, to a process for preparing them, and to the use thereof.

The present invention relates to aqueous polyurethane dispersions that are curable with UV radiation, to a process for preparing them, and to the use thereof.

Radiation-curable polyurethanes are widespread for the coating of woodbase materials, in the furniture industry, for example. In addition to requirements such as high hardness, coatings in the furniture industry are required in particular to emphasize the wood structure, an effect referred to as “grain highlighting”.

Water-dispersible, radiation-curable polyurethanes are known from EP 753531, for example, in which urethane acrylates are prepared on the basis of polyester acrylates, and from EP 942022, in which urethane acrylates are prepared on the basis of prepolymers containing acrylate groups. The polyurethane acrylate dispersions described therein do not adequately emphasize the wood structure.

In particular the examples of EP 753531 exhibit poor grain highlighting, as demonstrated in EP 1142947, example A therein, as a comparative example.

Aqueous polyurethane dispersions with good grain highlighting are described in EP 1142947, for example. This effect is attributed to the incorporation of a particular monomer (hydroxypivalic acid neopentyl glycol ester). The systems described therein do show significant improved grain highlighting (rating of 2) as compared with the prior art, but are nevertheless still in need of improvement as compared with the reference polyester acrylate Laromer® PE 55W (rating of 0).

The international patent application WO 2012/171833 (file reference PCT/EP2012/060644, filing date Jun. 6, 2012) discloses polyurethanes in dispersion in water that by virtue of their low average diameter of not more than 30 nm exhibit pronounced grain highlighting.

A disadvantage is that these polyurethanes, after drying and before UV curing, exhibit a distinct tack.

It is an object of the present invention to provide polyurethanes in dispersion in water and curable by UV radiation that on woodbase materials exhibit good performance properties, more particularly high hardness in conjunction with good grain highlighting. They ought to exhibit a reduced tack after drying and before curing. Moreover, for their dispersing, the polyurethanes are not to require solvents injurious to health, more particularly N-methylpyrrolidone (NMP).

The object is achieved by means of coating materials comprising at least two radiation-curable polyurethanes (A) and (B) in dispersion in water, polyurethane (A) having been synthesized from
(Aa) at least one aliphatic di- or polyisocyanate,
(Ab) at least one compound having at least one group that is reactive toward isocyanate groups, and having at least one radically polymerizable C═C double bond,
(Ac) optionally at least one compound having at least two groups that are reactive toward isocyanate groups and are selected from hydroxyl, mercapto, and primary and/or secondary amino groups,
(Ad) at least one compound having at least one group that is reactive toward isocyanate groups, and having at least one acid group,
(Ae) at least one basic compound for full or partial neutralization of the acid groups of the compounds Ad),
(Af) optionally at least one compound different from Ab), Ad), and Ae) and having only one group that is reactive toward isocyanate groups,
(Ag) optionally at least one di- or polyisocyanate other than Aa),
and the polyurethane (B) having been synthesized from
(Ba) at least one cycloaliphatic or aromatic di- or polyisocyanate,
(Bb) at least one compound having at least one group that is reactive toward isocyanate groups, and having at least one radically polymerizable C═C double bond,
(Bc) optionally at least one compound having at least two groups that are reactive toward isocyanate groups and are selected from hydroxyl, mercapto, and primary and/or secondary amino groups,
(Bd) at least one compound having at least one group that is reactive toward isocyanate groups, and having at least one acid group,
(Be) at least one basic compound for full or partial neutralization of the acid groups of the compounds Bd),
(Bf) optionally at least one compound different from Bb), Bd), and Be) and having only one group that is reactive toward isocyanate groups,
(Bg) optionally at least one aliphatic di- or polyisocyanate other than Ba),
(C) optionally further adjuvants selected from reactive diluents, photoinitiators, and customary coatings adjuvants,
(D) water, and
(E) optionally at least one di- and/or polyamine,
   the polyurethane (B) on its own after drying over a period of 16 to 24, preferably 24, hours at a wet film thickness of 200 μm, a temperature of 20 to 24° C., and a relative humidity of 40% to 60%, and before UV curing, having a pendulum damping to DIN 53157 of at least 50 swings, and the mixing ratio of polyurethane (A) and polyurethane (B) being selected such that the mixture thereof after drying over a period of 16 to 24, preferably 24, hours at a wet film thickness of 200 μm, a temperature of 20 to 24° C., and a relative humidity of 40% to 60%, and before UV curing, has a pendulum damping to DIN 53157 of at least 5, preferably at least 20, swings.

In one preferred embodiment the polyurethanes (A) and (B) of the invention as a mixture have a double bond density of at least 1.5 mol/kg, preferably at least 1.8, more preferably at least 2.0, very preferably 2.2 mol/kg.

The dispersions of the invention do not use any compounds which contain isocyanate groups and in which some or all of the isocyanate groups have been reacted with compounds known as blocking agents. By blocking agents are meant compounds which convert isocyanate groups into blocked (capped or protected) isocyanate groups which then, below a temperature referred to as the deblocking temperature, do not exhibit the customary reactions of a free isocyanate group. Such compounds with blocked isocyanate groups, not employed in accordance with the invention, are typically employed in dual-cure coating materials that are cured to completion by isocyanate group curing. Following their preparation, the polyurethane dispersions of the invention preferably no longer have substantially any free isocyanate groups, i.e., in general less than 1 wt % NCO, preferably less than 0.75, more preferably less than 0.66, and very preferably less than 0.3 wt % NCO (calculated with a molar weight of 42 g/mol).

### Polyurethane (A)

### Component Aa)

Component Aa) comprises at least one, as for example one to three, preferably one to two and more preferably precisely one aliphatic di- or polyisocyanate.

Aliphatic isocyanates are those having exclusively isocyanate groups which are bonded to carbon atoms which are part of linear or branched, acyclic chains, preferably those having exclusively isocyanate groups bonded to linear or branched, acyclic chains, and more preferably those having exclusively isocyanate groups bonded to linear or branched, acyclic hydrocarbon chains.

The aliphatic diisocyanates or polyisocyanates are preferably isocyanates having 4 to 20 C atoms. Examples of typical diisocyanates are 1,4-tetramethylene diisocyanate, 1,5-pentamethylene diisocyanate, 1,6-hexamethylene diisocyanate, 2-methyl-1,5-diisocyanatopentane, 1,8-octamethylene diisocyanate, 1,10-decamethylene diisocyanate, 1,12-dodecamethylene diisocyanate, 1,14-tetradecamethylene diisocyanate, 2,2,4- and 2,4,4-trimethylhexane diisocyanate, 1,3-bis(1-isocyanato-1-methylethyl)benzene (m-TMXDI), and derivatives of lysine diisocyanate. Mixtures of the stated diisocyanates may be present.

Preference is given to 1,6-hexamethylene diisocyanate and 2,2,4- and 2,4,4-trimethylhexane diisocyanate mixtures, particular preference to 1,6-hexamethylene diisocyanate.

There may also be mixtures of the stated diisocyanates present.

2,2,4- and 2,4,4-trimethylhexane diisocyanate take the form, for example, of a mixture in a ratio of 1.5:1 to 1:1.5, preferably 1.2:1-1:1.2, more preferably 1.1:1-1:1.1, and very preferably 1:1.

The polyisocyanates may be monomeric isocyanates having more than two isocyanate groups, or oligomers of the abovementioned diisocyanates.

An example of the former is triisocyanatononane (4-isocyanatomethyloctane 1,8-diisocyanate) or 2′-isocyanatoethyl 2,6-diisocyanatohexanoate.

The polyisocyanates are preferably compounds as follows:
1) Polyisocyanates containing isocyanurate groups and derived from aromatic, aliphatic and/or cycloaliphatic diisocyanates. Particular preference is given in this context to the corresponding aliphatic and/or cycloaliphatic isocyanatoisocyanurates and in particular to those based on hexamethylene diisocyanate and isophorone diisocyanate. The isocyanurates present are, in particular, trisisocyanatoalkyl and/or trisisocyanatocycloalkyl isocyanurates, which constitute cyclic trimers of the diisocyanates, or are mixtures with their higher homologs containing more than one isocyanurate ring. The isocyanatoisocyanurates generally have an NCO content of 10% to 30% by weight, in particular 15% to 25% by weight, and an average NCO functionality of 2.6 to 8.
   The polyisocyanates containing isocyanurate groups may to a minor extent also comprise urethane groups and/or allophanate groups, preferably with a bound-alcohol content of less than 2%, based on the polyisocyanate.
2) Polyisocyanates containing uretdione groups and having aromatically, aliphatically and/or cycloaliphatically attached isocyanate groups, preferably aliphatically and/or cycloaliphatically attached, and in particular those derived from hexamethylene diisocyanate or isophorone diisocyanate. Uretdione diisocyanates are cyclic dimerization products of diisocyanates.
   The polyisocyanates containing uretdione groups are obtained frequently in a mixture with other polyisocyanates, more particularly those specified under 1). Polyisocyanates containing uretdione groups typically have functionalities of 2 to 3.
   This also encompasses uretdione/isocyanurate mixtures of any desired composition especially with a monomeric uretdione (dimer) content of 1-40%, especially 3-15, especially 5-10%.
   For this purpose the diisocyanates can be reacted under reaction conditions under which not only uretdione groups but also the other polyisocyanates are formed, or the uretdione groups are formed first of all and are subsequently reacted to give the other polyisocyanates, or the diisocyanates are first reacted to give the other polyisocyanates, which are subsequently reacted to give products containing uretdione groups.
3) Polyisocyanates containing biuret groups and having aromatically, cycloaliphatically or aliphatically attached, preferably cycloaliphatically or aliphatically attached, isocyanate groups, especially tris(6-isocyanatohexyl)biuret or its mixtures with its higher homologs. These polyisocyanates containing biuret groups generally have an NCO content of 18% to 24% by weight and an average NCO functionality of 2.8 to 6.
4) Polyisocyanates containing urethane and/or allophanate groups and having aromatically, aliphatically or cycloaliphatically attached, preferably aliphatically or cycloaliphatically attached, isocyanate groups, as obtainable, for example, by reacting excess amounts of diisocyanate, such as of hexamethylene diisocyanate or of isophorone diisocyanate, with mono- or polyhydric alcohols. These polyisocyanates containing urethane and/or allophanate groups generally have an NCO content of 12% to 24% by weight and an average NCO functionality of 2.0 to 4.5. Polyisocyanates of this kind containing urethane and/or allophanate groups may be prepared without catalyst or, preferably, in the presence of catalysts, such as ammonium carboxylates or ammonium hydroxides, for example, or allophanatization catalysts, such as bismuth, cobalt, cesium, Zn(II) or Zr(IV) compounds, for example, in each case in the presence of monohydric, dihydric or polyhydric, preferably monohydric, alcohols.
   These polyisocyanates containing urethane groups and/or allophanate groups occur frequently in hybrid forms with the polyisocyanates specified under 1).
5) Polyisocyanates comprising oxadiazinetrione groups, derived preferably from hexamethylene diisocyanate or isophorone diisocyanate. Polyisocyanates of this kind comprising oxadiazinetrione groups are accessible from diisocyanate and carbon dioxide.
6) Polyisocyanates comprising iminooxadiazinedione groups, derived preferably from hexamethylene diisocyanate or isophorone diisocyanate. Polyisocyanates of this kind comprising iminooxadiazinedione groups are preparable from diisocyanates by means of specific catalysts.
7) Uretonimine-modified polyisocyanates.
8) Carbodiimide-modified polyisocyanates.
9) Hyperbranched polyisocyanates, of the kind known for example from DE-A1 10013186 or DE-A1 10013187.
10) Polyurethane-polyisocyanate prepolymers, from di- and/or polyisocyanates with alcohols.
11) Polyurea-polyisocyanate prepolymers.
12) The polyisocyanates 1)-11), preferably 1), 3), 4), and 6), can be converted, following their preparation, into polyisocyanates containing biuret groups or urethane/allophanate groups and having aromatically, cycloaliphatically or aliphatically attached, preferably (cyclo)aliphatically attached, isocyanate groups. The formation of biuret groups, for example, is accomplished by addition of water or by reaction with amines. The formation of urethane and/or allophanate groups is accomplished by reaction with monohydric, dihydric or polyhydric, preferably monohydric, alcohols, in the presence optionally of suitable catalysts. These polyisocyanates containing biuret or urethane/allophanate groups generally have an NCO content of 10% to 25% by weight and an average NCO functionality of 3 to 8.
13) Hydrophilically modified polyisocyanates, i.e., polyisocyanates which as well as the groups described under 1-12 also comprise groups which result formally from addition of molecules containing NCO-reactive groups and hydrophilizing groups to the isocyanate groups of the above molecules. The latter groups are nonionic groups such as alkylpolyethylene oxide and/or ionic groups derived from phosphoric acid, phosphonic acid, sulfuric acid or sulfonic acid, and/or their salts.
14) Modified polyisocyanates for dual cure applications, i.e., polyisocyanates which as well as the groups described under 1-11 also comprise groups resulting formally from addition of molecules containing NCO-reactive groups and UV-crosslinkable or actinic-radiation-crosslinkable groups to the isocyanate groups of the above molecules. These molecules are, for example, hydroxyalkyl (meth)acrylates and other hydroxy-vinyl compounds.

Preferred polyisocyanates are oligomers which contain isocyanurate, biuret, uretdione, allophanate, iminooxadiazinetrione and/or carbodiimide groups and are obtainable by oligomerization of at least one, preferably precisely one, of abovementioned diisocyanates, more preferably by reaction of 1,6-hexamethylene diisocyanate.

Particularly preferred polyisocyanates are oligomers that contain isocyanurate, uretdione and/or allophanate groups, more preferably oligomers that contain isocyanurate and/or allophanate groups, and, in one especially preferred embodiment, the compound Aa) is an oligomer containing allophanate groups and based on 1,6-hexamethylene diisocyanate where 1,6-hexamethylene diisocyanate is reacted with at least part of the compound Ab) to give an oligomer containing allophanate groups.

This reaction produces a compound having at least two free isocyanate groups, at least one allophanate group, and at least one radically polymerizable C═C double bond that is attached to the allophanate group by its group that is reactive toward isocyanate groups.

A component Aa) of this kind includes an allophanate group content (calculated as C₂N₂HO₃=101 g/mol) of 1 to 35 wt %, preferably of 5 to 30 wt %, more preferably of 10 to 35 wt %. The polyurethanes of the invention formed from the synthesis components Aa) to Ad) and also optionally Af) and Ag) contain 1 to 30 wt %, preferably from 1 to 25 wt %, more preferably from 2 to 20 wt % of allophanate groups. The component Aa) used in accordance with the invention further contains less than 5 wt % of uretdione.

Preference is given to compounds of the following formula

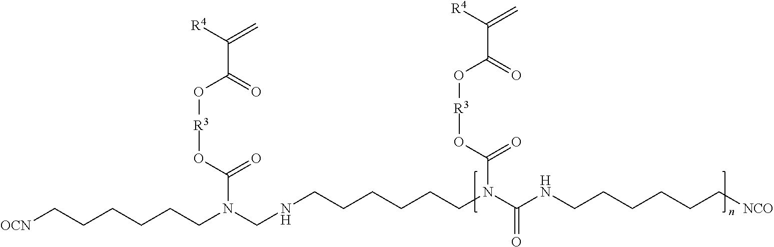

in which

R³ is a divalent aliphatic or cycloaliphatic, preferably aliphatic, radical, preferably hydrocarbon radical, which has 2 to 12, preferably 2 to 8, more preferably 2 to 4 carbon atoms,

R⁴ is hydrogen or methyl, preferably hydrogen, and

n can adopt on average 0 or a positive number, preferably values from 0 to 5, more preferably 0.5 to 3, very preferably 1 to 2.

Examples of R³ are 1,2-ethylene, 1,1-dimethyl-1,2-ethylene, 1,2-propylene, 1,3-propylene, 2-methyl-1,3-propylene, 2-ethyl-1,3-propylene, 2-butyl-2-ethyl-1,3-propylene, 2,2-dimethyl-1,3-propylene, 1,2-butylene, 1,3-butylene, 1,4-butylene, 1,5-pentylene, 1,6-hexylene, 2-ethyl-1,3-hexylene, 1,8-octylene, 2,4-diethyl-1,3-octylene or 1,10-decylene, preferably 1,2-ethylene, 1,2-propylene, 1,3-propylene, or 1,4-butylene, more preferably 1,2-ethylene or 1,2-propylene, and very preferably 1,2-ethylene.

This component preferably has an NCO content of 10 to 18, preferably 12 to 16, and more preferably 13 to 16 wt % and an average molecular weight of 600 to 1200, preferably 700 to 1000, and more preferably of 700 to 900 g/mol.

Compounds of these kinds are available commercially, for example, under the trade name Laromer® LR 9000 from BASF SE, Ludwigshafen.

The preparation of such compounds is known from WO 00/39183 A1, particularly example 1.1. and products 1 to 7 from table 1 therein.

### Component Ab)

Component Ab) comprises at least one, preferably one to three, more preferably one or two, and very preferably precisely one compound having at least one, as for example one or two, preferably precisely one group that is reactive toward isocyanate groups, and having at least one, as for example one to three, preferably one or two, and very preferably precisely one radically polymerizable C═C double bond.

Radically polymerizable C═C double bonds are vinyl ether, acrylate, or methacrylate groups, preferably acrylate or methacrylate groups, and more preferably acrylate groups.

Preferred compounds of components Ab) are, for example, the esters of dihydric or polyhydric alcohols with α,β-ethylenically unsaturated monocarboxylic and/or dicarboxylic acids and their anhydrides in which at least one hydroxyl group remains unreacted.

α,β-Ethylenically unsaturated monocarboxylic and/or dicarboxylic acids and their anhydrides that are used may be, for example, acrylic acid, methacrylic acid, fumaric acid, maleic acid, maleic anhydride, crotonic acid, itaconic acid, etc. Preference is given to using acrylic and methacrylic acid, more preferably acrylic acid.

Suitable dihydric or polyhydric alcohols are, for example, diols such as ethylene glycol, 1,2-propanediol, 1,3-propanediol, 1,1-dimethylethane-1,2-diol, 2-butyl-2-ethyl-1,3-propanediol, 2-ethyl-1,3-propanediol, 2-methyl-1,3-propanediol, neopentyl glycol, neopentyl glycol hydroxypivalate, 1,2-, 1,3-, or 1,4-butanediol, 1,6-hexanediol, 1,10-decanediol, bis(4-hydroxycyclohexane)isopropylidene, tetramethylcyclobutanediol, 1,2-, 1,3-, or 1,4-cyclohexanediol, cyclooctanediol, norbornanediol, pinanediol, decalindiol, 2-ethyl-1,3-hexanediol, 2,4-diethyloctane-1,3-diol, hydroquinone, bisphenol A, bisphenol F, bisphenol B, bisphenol S, 2,2-bis(4-hydroxycyclohexyl)propane, 1,1-, 1,2-, 1,3-, and 1,4-cyclohexanedimethanol, 1,2-, 1,3-, or 1,4-cyclohexanediol, and tricyclodecanedimethanol.

Suitable triols and polyols have, for example, 3 to 25, preferably 3 to 18, carbon atoms. These compounds include, for example, trimethylolbutane, trimethylolpropane, trimethylolethane, pentaerythritol, glycerol, ditrimethylolpropane, dipentaerythritol, ditrimethylolpropane, sorbitol, mannitol, diglycerol, threitol, erythritol, adonitol (ribitol), arabitol (lyxitol), xylitol, dulcitol (galactitol), maltitol, or isomalt.

The compounds of compound Ab) are preferably selected from 2-hydroxyethyl acrylate, 2-hydroxyethyl methacrylate, 2-hydroxypropyl acrylate, 2-hydroxypropyl methacrylate, 3-hydroxybutyl acrylate, 3-hydroxybutyl methacrylate, 4-hydroxybutyl acrylate, 4-hydroxybutyl methacrylate, 6-hydroxyhexyl acrylate, 6-hydroxyhexyl methacrylate, 3-hydroxy-2-ethylhexyl acrylate, 3-hydroxy-2-ethylhexyl methacrylate, trimethylolpropane mono- or diacrylate, pentaerythritol di- or triacrylate, and mixtures thereof.

With particular preference the compound Ab) is selected from the group consisting of 2-hydroxyethyl acrylate, 2-hydroxyethyl methacrylate, 2-hydroxypropyl acrylate, 2-hydroxypropyl methacrylate, 4-hydroxybutyl acrylate, and pentaerythritol triacrylate, very preferably from the group consisting of 2-hydroxyethyl acrylate, 2-hydroxyethyl methacrylate, 2-hydroxypropyl acrylate, and 2-hydroxypropyl methacrylate, and more particularly 2-hydroxyethyl acrylate or 2-hydroxyethyl methacrylate.

### Component Ac)

The optional component Ac) comprises at least one compound having at least two, as for example 2 to 4, preferably 2 to 3, and more preferably precisely 2 groups that are reactive toward isocyanate groups and are selected from hydroxyl, mercapto, and primary and/or secondary amino groups, preferably selected from the group consisting of hydroxyl and primary amino groups, and more preferably being hydroxyl groups.

The compounds Ac) are low molecular mass compounds with a molar weight below 500 g/mol, preferably below 400 g/mol, more preferably below 250 g/mol.

The low molecular mass alcohols Ac) may be aliphatic or cycloaliphatic, preferably aliphatic.

The hydroxyl groups may preferably be secondary or primary, preferably primary.

Particularly preferred are alcohols having 2 to 20 carbon atoms. Preferred more particularly are short-chain diols which are stable to hydrolysis and have 4 to 20, preferably 6 to 12, carbon atoms. With very particular preference the compounds Ac) are alkanediols.

Examples of compounds Ac) are ethylene glycol, 1,2-propanediol, 1,3-propanediol, 1,1-dimethylethane-1,2-diol, 2-butyl-2-ethyl-1,3-propanediol, 2-ethyl-1,3-propanediol, 2-methyl-1,3-propanediol, neopentyl glycol, neopentyl glycol hydroxypivalate, 1,2-, 1,3-, or 1,4-butanediol, 1,6-hexanediol, 1,10-decanediol, bis(4-hydroxycyclohexane)isopropylidene, tetramethylcyclobutanediol, 1,2-, 1,3-, or 1,4-cyclohexanediol, cyclooctanediol, norbornanediol, pinanediol, decalindiol, 2-ethyl-1,3-hexanediol, 2,4-diethyloctane-1,3-diol, hydroquinone, bisphenol A, bisphenol F, bisphenol B, bisphenol S, 2,2-bis(4-hydroxycyclohexyl)propane, 1,1-, 1,2-, 1,3-, and 1,4-cyclohexanedimethanol, 1,2-, 1,3-, or 1,4-cyclohexanediol.

Preference is given to ethylene glycol, 1,2-propanediol, 1,3-propanediol, neopentyl glycol, 1,4-butanediol, 1,6-hexanediol, 2,2-bis(4-hydroxycyclohexyl)propane, 1,1-, 1,2-, 1,3-, and 1,4-cyclohexanedimethanol, 1,2-, 1,3-, or 1,4-cyclohexanediol, and particular preference to ethylene glycol, 1,2-propanediol, 1,3-propanediol, neopentyl glycol, 1,4-butanediol, or 1,6-hexanediol.

In accordance with the invention no substantial amounts are used of relatively high molecular mass diols or polyols, having a molar weight upward of 500 g/mol.

By “no substantial amounts” here is meant that the fraction of the OH groups in the relatively high molecular mass diols or polyols, as a proportion of the total OH groups used from the compounds Ab), Ac), Ad), and Af), is not more than 20 mol %, preferably not more than 15 mol %, more preferably not more than 10, very preferably not more than 5, and more particularly 0 mol %.

The aforementioned components Ac) may be used individually or as mixtures.

### Component Ad)

Component Ad) is at least one, preferably precisely one, compound having at least one, as for example one to 3, preferably one or 2, more preferably precisely two groups that are reactive toward isocyanate groups, and having at least one, preferably precisely one, acid group.

The acid groups in the compounds of component Ad) are preferably selected from carboxylic acid groups, sulfonic acid groups, phosphonic acid groups, and phosphoric acid groups. Carboxylic acid and sulfonic acid groups are preferred, carboxylic acid groups particularly preferred.

Suitable compounds Ad) having at least one isocyanate-reactive group and also at least one carboxylic acid or sulfonic acid group include, in particular, aliphatic monomercapto-, monohydroxy-, and monoamino- and iminocarboxylic acids and corresponding sulfonic acids, such as mercaptoacetic acid (thioglycolic acid), mercaptopropionic acid, mercaptosuccinic acid, hydroxyacetic acid, hydroxpropionic acid (lactic acid), hydroxysuccinic acid, hydroxypivalic acid, dimethylolpropionic acid, dimethylolbutyric acid, hydroxydecanoic acid, hydroxydodecanoic acid, 12-hydroxystearic acid, N-(2′-aminoethyl)-3-aminopropionic acid, hydroxyethanesulfonic acid, hydroxypropanesulfonic acid, mercaptoethanesulfonic acid, mercaptopropanesulfonic acid, aminoethanesulfonic acid, aminopropanesulfonic acid, glycine (aminoacetic acid), N-cyclohexylaminoethanesulfonic acid, N-cyclohexylaminopropanesulfonic acid, or iminodiacetic acid.

Preference is given to dimethylolpropionic acid and dimethylolbutyric acid, particular preference to dimethylolpropionic acid.

### Component Ae)

Component Ae) is at least one basic compound for full or partial neutralization of the acid groups of the compounds Ad).

Basic compounds Ae) contemplated for full or partial neutralization of the acid groups in the compounds Ad) include organic and inorganic bases such as primary, secondary, or tertiary amines and alkali metal and alkaline earth metal hydroxides, oxides, carbonates, and hydrogencarbonates, and also ammonia. Preferred full or partial neutralization is with amines such as ethanolamine or diethanolamine and more particularly with tertiary amines, such as triethylamine, triethanolamine, dimethylethanolamine, or diethylethanolamine. The amounts of chemically bonded acid groups introduced and the extent of the neutralization of the acid groups (which is usually 40 to 100% of the equivalence basis) is preferably to be sufficient to ensure dispersing of the polyurethanes in an aqueous medium, as is familiar to the skilled person.

### Component Af)

In the dispersions of the invention, as component Af), it is possible to use at least one further compound having a group that is reactive toward isocyanate groups. This group may be a hydroxyl, mercapto, or primary or secondary amino group. Suitable compounds Af) are the typical compounds known to the skilled person, which are typically used as so-called stoppers for lowering the number of reactive free isocyanate groups and/or for modifying the polyurethane properties in connection with polyurethane production. They include, for example, monofunctional alcohols, such as methanol, ethanol, n-propanol, isopropanol, n-butanol, etc. Other suitable components Af) are amines with a primary or secondary amino group, such as, for example, methylamine, ethylamine, n-propylamine, diisopropylamine, dimethylamine, diethylamine, di-n-propylamine, diisopropylamine, etc.

### Component Ag)

In the dispersions of the invention it is possible as optional components Ag), in minor amounts, to use at least one polyisocyanate different from the compounds of components Aa). Polyisocyanates used in accordance with the invention as components Ag) do not include polyisocyanates in which the isocyanate groups have been reacted with a blocking agent.

Preferred compounds Ag) are polyisocyanates having an NCO functionality of 2 to 4.5, more preferably 2 to 3.5. As component Ag), preference is given to using aliphatic, cycloaliphatic, and araliphatic diisocyanates. These may for example be the diisocyanates listed above under Aa), but they are different from the compound Aa). Preferred compounds Ag) are those which as well as two or more isocyanate groups also contain a group selected from the group consisting of urethane, urea, biuret, allophanate, carbodiimide, uretonimine, uretdione, and isocyanurate groups.

The compound Ag) preferably comprises cycloaliphatic or aromatic, preferably cycloaliphatic, di- and polyisocyanates.

Cycloaliphatic isocyanates are those which have at least one isocyanate group that is bonded to a carbon atom that is part of a fully saturated ring system, preferably those which have at least one isocyanate group that is bonded to a carbon atom that is part of a nonaromatic carbocyclic ring system.

Aromatic isocyanates are those which have at least one isocyanate group which is bonded to a carbon atom which is part of an aromatic ring system.

Examples of cycloaliphatic diisocyanates are 1,4-, 1,3-, or 1,2-diisocyanatocyclohexane, 4,4′- or 2,4′-di(isocyanatocyclohexyl)methane, isophorone diisocyanate, 1,3- or 1,4-bis(isocyanatomethyl)cyclohexane, 2,4- and 2,6-diisocyanato-1-methylcyclo-hexane. Examples of aromatic diisocyanates are 2,4- or 2,6-tolylene diisocyanate, m- or p-xylylene diisocyanate, 2,4′- or 4,4′-diisocyanatodiphenylmethane, 1,3- or 1,4-phenylene diisocyanate, 1-chloro-2,4-phenylene diisocyanate, 1,5-naphthylene diisocyanate, diphenylene 4,4′-diisocyanate, 4,4′-diisocyanato-3,3′-dimethyldiphenyl diisocyanate, 3-methyldiphenylmethane 4,4′-diisocyanate, and diphenyl ether 4,4′-diisocyanate. Mixtures of the stated diisocyanates may be present.

Employed with preference as component Ag) are isophorone diisocyanate, 1,3- and 1,4-bis(isocyanatomethyl)cyclohexane, their isocyanurates, biurets, and mixtures thereof.

In a preferred embodiment of the present invention use is not made of any amounts, or of no substantial amounts, of component Ag), preferably no component Ag).

By “no substantial amounts” is meant here that the fraction of the NCO groups in component Ag) as a proportion of the total NCO groups used from the compounds Aa) and Ag) is not more than 20 mol %, preferably not more than 15 mol %, more preferably not more than 10, very preferably not more than 5, and more particularly 0 mol %.

In one preferred embodiment the polyurethane (A) after drying and before curing has a glass transition temperature Tg (extrapolated onset temperature, T_{eig}) as determined by the DSC (Differential Scanning calorimetry) method in accordance with ASTM 3418/82 with a heating rate of 10° C./min, of less than 10 and preferably not more than 0 and more preferably not more than −10° C.

### Polyurethane (B)

The polyurethane (B) present in the coating materials of the invention has been synthesized as follows from the synthesis components Ba) to Bg):

The isocyanate component of the polyurethane (B) comprises at least one, preferably one to three, more preferably one or two, and very preferably precisely one cycloaliphatic or aromatic, preferably cycloaliphatic, di- or polyisocyanate. Polyisocyanates used as components Ba) do not include any polyisocyanates in which the isocyanate groups have been reacted with a blocking agent.

Preferred compounds Ba) are polyisocyanates having an NCO functionality of 2 to 4.5, more preferably 2 to 3.5. One preferred embodiment uses as component Ba) aliphatic, cycloaliphatic, and araliphatic, preferably cycloaliphatic, diisocyanates.

In another preferred embodiment the compounds Ba) are compounds which as well as two or more isocyanate groups also have a group selected from the group consisting of urethane, urea, biuret, allophanate, carbodiimide, uretonimine, uretdione, and isocyanurate groups.

The compound Ba) preferably comprises cycloaliphatic or aromatic, preferably cycloaliphatic, di- and polyisocyanates.

Cycloaliphatic isocyanates are those which have at least one isocyanate group that is bonded to a carbon atom that is part of a fully saturated ring system, preferably those which have at least one isocyanate group that is bonded to a carbon atom that is part of a nonaromatic carbocyclic ring system.

Aromatic isocyanates are those which have at least one isocyanate group which is bonded to a carbon atom which is part of an aromatic ring system.

Examples of cycloaliphatic diisocyanates are 1,4-, 1,3-, or 1,2-diisocyanatocyclohexane, 4,4′- or 2,4′-di(isocyanatocyclohexyl)methane, isophorone diisocyanate, 1,3- or 1,4-bis(isocyanatomethyl)cyclohexane, 2,4- and 2,6-diisocyanato-1-methylcyclo-hexane. Examples of aromatic diisocyanates are 2,4- or 2,6-tolylene diisocyanate, m- or p-xylylene diisocyanate, 2,4′- or 4,4′-diisocyanatodiphenylmethane, 1,3- or 1,4-phenylene diisocyanate, 1-chloro-2,4-phenylene diisocyanate, 1,5-naphthylene diisocyanate, diphenylene 4,4′-diisocyanate, 4,4′-diisocyanato-3,3′-dimethyldiphenyl diisocyanate, 3-methyldiphenylmethane 4,4′-diisocyanate, and diphenyl ether 4,4′-diisocyanate. Mixtures of the stated diisocyanates may be present.

Employed with preference as component Ba) are isophorone diisocyanate, 4,4′ or 2,4′-di(isocyanatocyclohexyl)methane, their isocyanurates, biurets, and mixtures thereof.

Particular preference is given to using, as component Ba), isophorone diisocyanate, 4,4′- or 2,4′-di(isocyanatocyclohexyl)methane, or their isocyanurates.

Very particular preference as component Ba) is given to isophorone diisocyanate and to an isocyanurate based on isophorone diisocyanate, more particularly to an isocyanurate based on isophorone diisocyanate.

The component Bb) may in principle comprise the same compounds as described above under Ab), but they are independent of the component Ab) used for the polyurethane (A).

The compounds of component Bb) are preferably selected from 2-hydroxyethyl acrylate, 2-hydroxyethyl methacrylate, 2-hydroxypropyl acrylate, 2-hydroxypropyl methacrylate, 3-hydroxybutyl acrylate, 3-hydroxybutyl methacrylate, 4-hydroxybutyl acrylate, 4-hydroxybutyl methacrylate, 6-hydroxyhexyl acrylate, 6-hydroxyhexyl methacrylate, 3-hydroxy-2-ethylhexyl acrylate, 3-hydroxy-2-ethylhexyl methacrylate, trimethylolpropane mono- or diacrylate, pentaerythritol di- or triacrylate, and mixtures thereof.

With particular preference the compound Bb) is selected from the group consisting of 2-hydroxyethyl acrylate, 2-hydroxyethyl methacrylate, 2-hydroxypropyl acrylate, 2-hydroxypropyl methacrylate, 4-hydroxybutyl acrylate, and pentaerythritol triacrylate, very preferably selected from the group consisting of 2-hydroxyethyl acrylate, 2-hydroxyethyl methacrylate, 2-hydroxypropyl acrylate, and 2-hydroxypropyl methacrylate, and more particular it is 2-hydroxyethyl acrylate or 2-hydroxyethyl methacrylate.

Component Bc) may in principle comprise the same compounds as described above under Ac), but they are independent of the component Ac) used for the polyurethane (A).

In one preferred embodiment the component Bc) comprises at least one cycloaliphatic diol and/or one aliphatic diol in which the two hydroxyl groups are separated from one another by not more than four atoms—that is, it is an aliphatic 1,2-, 1,3-, or 1,4-diol.

A cycloaliphatic diol here means a diol which has at least one fully saturated ring system, preferably a diol in which at least one and preferably both hydroxyl groups are bonded to a fully saturated ring system.

Aliphatic diols are those diols which have exclusively linear or branched, acyclic chains.

Particularly preferred compounds Bc) are ethylene glycol, 1,2-propanediol, 1,3-propanediol, 1,1-dimethylethane-1,2-diol, 2-butyl-2-ethyl-1,3-propanediol, 2-ethyl-1,3-propanediol, 2-methyl-1,3-propanediol, neopentyl glycol, 1,2-, 1,3- or 1,4-butanediol, bis(4-hydroxycyclohexane)isopropylidene, tetramethylcyclobutanediol, 1,2-, 1,3- or 1,4-cyclohexanediol, cyclooctanediol, norbornanediol, pinanediol, decalinediol, 2,2-bis(4-hydroxycyclohexyl)propane, 1,1-, 1,2-, 1,3-, and 1,4-cyclohexanedimethanol, and 1,2-, 1,3-, or 1,4-cyclohexanediol.

Especially preferred are 2,2-bis(4-hydroxycyclohexyl)propane and 1,1-, 1,2-, 1,3-, and 1,4-cyclohexanedimethanol.

It is preferred not to use any substantial amounts of relatively high molecular mass diols or polyols, having a molar weight of above 500 g/mol.

“Any substantial amounts” here means that the fraction of the OH groups in the relatively high molecular mass diols or polyols, as a proportion of the total OH groups used from the compounds Bb), Bc), Bd), and Bf), is not more than 20 mol %, preferably not more than 15 mol %, more preferably not more than 10, very preferably not more than 5, and more particularly 0 mol %.

The aforementioned components Bc) may be used individually or as mixtures.

Component Bd) may in principle comprise the same compounds as described above under Ad), but they are independent of the component Ad) used for the polyurethane (A).

Preferred compounds Bd) are mercaptoacetic acid (thioglycolic acid), hydroxyacetic acid, hydroxypropionic acid (lactic acid), hydroxysuccinic acid, hydroxypivalinic acid, dimethylolpropionic acid, dimethylolbutyric acid, N—(Z-aminoethyl)-3-aminopropionic acid, hydroxyethanesulfonic acid, hydroxypropanesulfonic acid, aminoethanesulfonic acid, aminopropanesulfonic acid, glycine (aminoacetic acid), N-cyclohexylaminoethanesulfonic acid, or N-cyclohexylaminopropanesulfonic acid.

Dimethylolpropionic acid and dimethylolbutyric acid are preferred, dimethylolpropionic acid particularly preferred.

Component Be) may in principle comprise the same compounds as described above under Ae), but they are independent of the component Ae) used for the polyurethane (A).

Preferred compounds Be) are ethanolamine, diethanolamine, triethylamine, triethanolamine, dimethylethanolamine, and diethylethanolamine. The amounts of chemically bonded acid groups introduced and the extent of the neutralization of the acid groups (which is usually 40 to 100% of the equivalence basis) is preferably to be sufficient to ensure dispersal of the polyurethanes in an aqueous medium, as is familiar to the skilled person.

Component Bf) may in principle comprise the same compounds as described above under Af), but they are independent of the component Af) used for the polyurethane (A).

Preferred compounds Bf) are methanol, ethanol, n-propanol, isopropanol, n-butanol, methylamine, ethylamine, n-propylamine, diisopropylamine, dimethylamine, diethylamine, di-n-propylamine, and diisopropylamine.

The optional component Bg) comprises at least one, as for example one to three, preferably one to two, and more preferably precisely one aliphatic di- or polyisocyanate, preferably polyisocyanate.

Aliphatic isocyanates are those having exclusively isocyanate groups which are bonded to carbon atoms which are part of linear or branched, acyclic chains, preferably those having exclusively isocyanate groups bonded to linear or branched, acyclic chains, or more preferably those having exclusively isocyanate groups bonded to linear or branched, acyclic hydrocarbon chains.

The aliphatic diisocyanates or polyisocyanates are preferably isocyanates having 4 to 20 C atoms. Examples of typical diisocyanates are 1,4-tetramethylene diisocyanate, 1,5-pentamethylene diisocyanate, 1,6-hexamethylene diisocyanate, 2-methyl-1,5-diisocyanatopentane, 1,8-octamethylene diisocyanate, 1,10-decamethylene diisocyanate, 1,12-dodecamethylene diisocyanate, 1,14-tetradecamethylene diisocyanate, 2,2,4- and 2,4,4-trimethylhexane diisocyanate, 1,3-bis(1-isocyanato-1-methylethyl)benzene (m-TMXDI), and derivatives of lysine diisocyanate. Mixtures of the stated diisocyanates may be present.

Preference is given to 1,6-hexamethylene diisocyanate and 2,2,4- and 2,4,4-trimethylhexane diisocyanate mixtures, particular preference to 1,6-hexamethylene diisocyanate.

There may also be mixtures of the stated diisocyanates present.

2,2,4- and 2,4,4-trimethylhexane diisocyanate take the form, for example, of a mixture in a ratio of 1.5:1 to 1:1.5, preferably 1.2:1-1:1.2, more preferably 1.1:1-1:1.1, and very preferably 1:1.

The polyisocyanates may be monomeric isocyanates having more than two isocyanate groups, or oligomers of the abovementioned diisocyanates.

An example of the former is triisocyanatononane (4-isocyanatomethyloctane 1,8-diisocyanate) or 2′-isocyanatoethyl 2,6-diisocyanatohexanoate.

Examples of the latter are oligomers that contain iocyanurate, biuret, uretdione, allophanate, iminooxadiazinetrione and/or carbodiimide groups and that are obtainable by oligomerization of at least one, preferably precisely one, of the abovementioned diisocyanates, more preferably by reaction of 1,6-hexamethylene diisocyanate.

Preferred polyisocyanates are oligomers that contain isocyanurate, uretdione and/or allophanate groups, more preferably oligomers that contain isocyanurate and/or allophanate groups, and, in one especially preferred embodiment, the compound Bg) is an oligomer containing allophanate groups and based on 1,6-hexamethylene diisocyanate where 1,6-hexamethylene diisocyanate is reacted with at least part of the compound Bb) to give an oligomer containing allophanate groups.

This reaction produces a compound having at least two free isocyanate groups, at least one allophanate group, and at least one radically polymerizable C═C double bond that is attached to the allophanate group by its group that is reactive toward isocyanate groups.

A component Bg) of this kind includes an allophanate group content (calculated as C₂N₂HO₃=101 g/mol) of 1 to 35 wt %, preferably of 5 to 30 wt %, more preferably of 10 to 35 wt %. The polyurethanes (B) formed from the synthesis components Ba) to Bd) and also optionally Bf) and Bg) contain 1 to 30 wt %, preferably from 1 to 25 wt %, more preferably from 2 to 20 wt % of allophanate groups. The component Bg) used further contains less than 5 wt % of uretdione as a rule.

Preference is given to compounds of the following formula

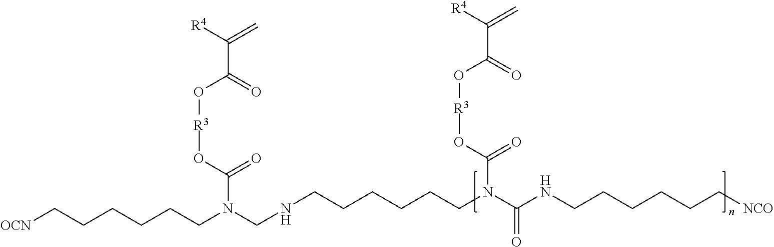

in which

R³ is a divalent aliphatic or cycloaliphatic, preferably aliphatic, radical, preferably hydrocarbon radical, which has 2 to 12, preferably 2 to 8, more preferably 2 to 4 carbon atoms,

R⁴ is hydrogen or methyl, preferably hydrogen, and

n can adopt on average 0 or a positive number, preferably values from 0 to 5, more preferably 0.5 to 3, very preferably 1 to 2.

Examples of R³ are 1,2-ethylene, 1,1-dimethyl-1,2-ethylene, 1,2-propylene, 1,3-propylene, 2-methyl-1,3-propylene, 2-ethyl-1,3-propylene, 2-butyl-2-ethyl-1,3-propylene, 2,2-dimethyl-1,3-propylene, 1,2-butylene, 1,3-butylene, 1,4-butylene, 1,5-pentylene, 1,6-hexylene, 2-ethyl-1,3-hexylene, 1,8-octylene, 2,4-diethyl-1,3-octylene or 1,10-decylene, preferably 1,2-ethylene, 1,2-propylene, 1,3-propylene, or 1,4-butylene, more preferably 1,2-ethylene or 1,2-propylene, and very preferably 1,2-ethylene.

This component preferably has an NCO content of 10 to 18, preferably 12 to 16, and more preferably 13 to 16 wt % and an average molecular weight of 600 to 1200, preferably 700 to 1000, and more preferably of 700 to 900 g/mol.

Compounds of these kinds are available commercially, for example, under the trade name Laromer® LR 9000 from BASF SE, Ludwigshafen.

The preparation of such compounds is known from WO 00/39183 A1, particularly example 1.1. and products 1 to 7 from table 1 therein.

In a preferred embodiment of the present invention the amounts that are used of component Bg) are zero or only minor amounts, preferably only minor amounts of Bg).

By “only minor amounts” here is meant that the fraction of the NCO groups in component Bg), as a proportion of the total NCO groups used from the compounds Ba) and Bg), is less than 50 mol %, preferably not more than 40 mol %, more preferably not more than 30, and very preferably not more than 20 mol %.

In one preferred embodiment of the present invention the polyurethane (B) on its own after drying and before curing exhibits a pendulum damping to DIN 53157 of at least 50 swings.

In another, alternative, equally preferred embodiment, the polyurethane (B) comprises as synthesis component Ba) at least one cycloaliphatic di- and/or polyisocyanate and/or as synthesis component Bc) at least one cycloaliphatic diol and/or an aliphatic diol in which the two hydroxyl groups are separated from one another by not more than four carbon atoms—that is, it is an aliphatic 1,2-, 1,3-, or 1,4-diol.

With particular preference component Ba) comprises isophorone diisocyanate and/or a polyisocyanate that contains isocyanurate groups and is based on isophorone diisocyanate and/or component Bc) is selected from the group consisting of ethylene glycol, 1,2-propanediol, 1,3-propanediol, 2-butyl-2-ethyl-1,3-propanediol, neopentyl glycol, 1,4-butanediol, bis(4-hydroxycyclohexane)isopropylidene, 1,2-, 1,3-, or 1,4-cyclohexanediol, and 1,2-, 1,3-, and 1,4-cyclohexanedimethanol.

With very particular preference component Ba) is a polyisocyanate that contains isocyanurate groups and is based on isophorone diisocyanate, and optionally component Bc) additionally may be selected from the group consisting of ethylene glycol, 1,2-propanediol, 1,3-propanediol, 2-butyl-2-ethyl-1,3-propanediol, neopentyl glycol, 1,4-butanediol, bis(4-hydroxycyclohexane)isopropylidene, 1,2-, 1,3-, or 1,4-cyclohexanediol, 1,2-, 1,3-, and 1,4-cyclohexanedimethanol.

In one preferred embodiment the polyurethane (B) after drying and before curing has a glass transition temperature Tg (extrapolated onset temperature, T_{eig}), as determined by the DSC (Differential Scanning calorimetry) method in accordance with ASTM 3418/82 with a heating rate of 10° C./min, of more than 10° C., preferably at least 15° C., and more preferably at least 40° C.

The urethane (meth)acrylates (A) and (B) are preparable by reacting the respective components, optionally after staggered addition of individual components, with one another at temperatures of 25 to 100° C., preferably 40 to 90° C., over a period of 3 to 20 hours, preferably of 5 to 12 hours, with stirring or circulatory pumping.

During the reaction, the temperature may stay the same or may be increased continuously or in steps.

The reaction is preferably accelerated by addition of a suitable catalyst. Such catalysts are known from the literature, as for example from G. Oertel (editor), Polyurethane, 3rd edition 1993, Carl Hanser Verlag, Munich-Vienna, pages 104 to 110, section 3.4.1. “Katalysatoren”; preferred are organic amines, more particularly tertiary aliphatic, cycloaliphatic, or aromatic amines, Brønsted acids and/or Lewis-acidic organometallic compounds, with Lewis-acidic organometallic compounds being particularly preferred. Preferably these are Lewis-acidic organometallic compounds, for which, for example, tin compounds are suitable, such as, for example, tin(II) salts of organic carboxylic acids, examples being tin(II) diacetate, tin(II) dioctoate, tin(II) bis(ethylhexanoate), and tin(II) dilaurate, and the dialkyltin(IV) salts of organic carboxylic acids, examples being dimethyltin diacetate, dibutyltin diacetate, dibutyltin dibutyrate, dibutyltin bis(2-ethylhexanoate), dibutyltin dilaurate, dibutyltin maleate, dioctyltin dilaurate, and dioctyltin diacetate. It is possible, moreover, to use zinc(II) salts, such as zinc(II) dioctoate, for example.

Metal complexes are possible as well, such as acetylacetonates of iron, titanium, aluminum, zirconium, manganese, nickel, zinc, and cobalt.

Other metal catalysts are described by Blank et al. in Progress in Organic Coatings, 1999, vol. 35, pages 19-29.

Tin-free and zinc-free alternatives used include compounds of zirconium, of bismuth, of titanium, and of aluminum. These are, for example, zirconium tetraacetylacetonate (e.g., K-KAT® 4205 from King Industries), zirconium dionates (e.g., K-KAT® XC-9213, XC-A 209, and XC-6212 from King Industries), and aluminum dionate (e.g., K-KAT® 5218 from King Industries).

Zinc compounds and bismuth compounds that are contemplated include those employing the following anions: F⁻, Cl⁻, ClO⁻, ClO₃⁻, ClO₄⁻, Br⁻, I⁻, IO₃⁻, CN⁻, OCN⁻, NO₂⁻, NO₃⁻, HCO₃⁻, CO₃²⁻, S²⁻, SH⁻, HSO₃⁻, SO₃²⁻, HSO₄⁻, SO₄²⁻, S₂O₂²⁻, S₂O₄²⁻, S₂O₅²⁻, S₂O₆²⁻, S₂O₇²⁻, S₂O₈²⁻, H₂PO₂⁻, H₂PO₄⁻, HPO₄²⁻, PO₄³⁻, P₂O₇⁴⁻, (OCₙH₂ₙ₊₁)⁻, (CₙH₂ₙ₋₁O₂)⁻, (CₙH₂ₙ₋₃O₂)⁻′, and (Cₙ₊₁H₂ₙ₋₂O₄)²⁻, where n stands for the numbers 1 to 20. Preference here is given to the carboxylates in which the anion conforms to the formulae (CₙH₂ₙ₋₁O₂)⁻ and (Cₙ₊₁H₂ₙ₋₂O₄)²⁻ with n being 1 to 20. Particularly preferred salts have monocarboxylate anions of the general formula (CₙH₂ₙ₋₁O₂)⁻, where n stands for the numbers 1 to 20. Particularly noteworthy in this context are formate, acetate, propionate, hexanoate, neodecanoate, and 2-ethylhexanoate.

Among the zinc catalysts the zinc carboxylates are preferred, more preferably those of carboxylates which have at least six carbon atoms, very preferably at least eight carbon atoms, more particularly zinc(II) diacetate or zinc(II) dioctoate or zinc(II) neodecanoate. Commercially available catalysts are, for example, Borchi® Kat 22 from OMG Borchers GmbH, Langenfeld, Germany.

Among the bismuth catalysts the bismuth carboxylates are preferred, more preferably those of carboxylates which have at least six carbon atoms, more particularly bismuth octoates, ethylhexanoates, neodecanoates, or pivalates; examples include K-KAT 348, XC-B221, XC-C227, XC 8203, and XK-601 from King Industries, TIB KAT 716, 716LA, 716XLA, 718, 720, 789 from TIB Chemicals, and those from Shepherd Lausanne, and also, for example, Borchi® Kat 24, 315, and 320 from OMG Borchers GmbH, Langenfeld, Germany.

These may also be mixtures of different metals, as in Borchi® Kat 0245 from OMG Borchers GmbH, Langenfeld, Germany, for example.

Among the titanium compounds the titanium tetraalkoxides Ti(OR)₄ are preferred, more preferably those of alcohols ROH having 1 to 8 carbon atoms, examples being methanol, ethanol, isopropanol, n-propanol, n-butanol, isobutanol, sec-butanol, tert-butanol, n-hexanol, n-heptanol, and n-octanol, preferably methanol, ethanol, isopropanol, n-propanol, n-butanol, and tert-butanol, more preferably isopropanol and n-butanol.

These catalysts are suitable for solvent-based, water-based and/or blocked systems.

Molybdenum, tungsten, and vanadium catalysts are described in particular for the reaction of blocked polyisocyanates in WO 2004/076519 and WO 2004/076520.

Preferred Lewis-acidic organometallic compounds are dimethyltin diacetate, dibutyltin dibutyrate, dibutyltin bis(2-ethylhexanoate), dibutyltin dilaurate, dioctyltin dilaurate, zinc(II) dioctoate, zirconium acetylacetonate, zirconium 2,2,6,6-tetramethyl-3,5-heptanedionate, and bismuth 2-ethylhexanoate.

Particularly preferred, however, are dibutyltin dilaurate, bismuth neodecanoate, and bismuth 2-ethylhexanoate; bismuth neodecanoate and bismuth 2-ethylhexanoate are especially preferred.

It is possible to boost the activity of the catalysts additionally through the presence of acids—by means, for example, of acids having a pKa of <2.5, as described in EP 2316867 A1, or having a pKa of between 2.8 and 4.5, as described in WO 04/029121 A1. The use is preferred of acids having a pKa of not more than 4.8, more preferably of not more than 2.5.

It is also conceivable to carry out the reaction without catalyst, though in that case the reaction mixture has to be exposed to relatively high temperatures and/or relatively long reaction times.

In one preferred embodiment of the present invention the urethane (meth)acrylates (A) and (B) are each prepared tinlessly.

In order to prevent unwanted polymerization of the (meth)acrylate groups during the reaction, polymerization inhibitors may be added. Inhibitors of this kind are described for example in WO 03/035596, page 5, line 35 to page 10, line 4, to which reference may herewith be made in the context of the present disclosure content.

The reaction may be considered at an end when the NCO value has attained the theoretical conversion value of at least 95%, preferably at least 97%, and more preferably at least 98%.

### Component (C)

The dispersion of the invention may comprise at least one further compound of the kind used typically as reactive diluent. Examples thereof include the reactive diluents of the kind described in P. K. T. Oldring (editor), Chemistry & Technology of UV & EB Formulations for Coatings, Inks & Paints, Vol. II, Chapter III: Reactive Diluents for UV & EB Curable Formulations, Wiley and SITA Technology, London 1997.

Preferred reactive diluents are compounds that are different from component Ab) and that have at least one radically polymerizable C═C double bond.

Reactive diluents are, for example, esters of (meth)acrylic acid with alcohols having 1 to 20 C atoms, examples being methyl (meth)acrylate, ethyl (meth)acrylate, butyl (meth)acrylate, 2-ethylhexyl (meth)acrylate, 2-hydroxyethyl acrylate, 4-hydroxybutyl acrylate, dihydrodicyclopentadienyl acrylate, vinyl aromatic compounds, e.g., styrene, divinylbenzene, α,β-unsaturated nitriles, e.g., acrylonitrile, methacrylonitrile, α,β-unsaturated aldehydes, e.g., acrolein, methacrolein, vinyl esters, e.g., vinyl acetate, vinyl propionate, halogenated ethylenically unsaturated compounds, e.g., vinyl chloride, vinylidene chloride, conjugated unsaturated compounds, e.g., butadiene, isoprene, chloroprene, monounsaturated compounds, e.g., ethylene, propylene, 1-butene, 2-butene, isobutene, cyclic monounsaturated compounds, e.g., cyclopentene, cyclohexene, cyclododecene, N-vinylformamide, allylacetic acid, vinylacetic acid, monoethylenically unsaturated carboxylic acids having 3 to 8 C atoms and also their water-soluble alkali metal, alkaline earth metal, or ammonium salts such as, for example, the following: acrylic acid, methacrylic acid, dimethylacrylic acid, ethacrylic acid, maleic acid, citraconic acid, methylenemalonic acid, crotonic acid, fumaric acid, mesaconic acid, and itaconic acid, N-vinylpyrrolidone, N-vinyl lactams, such as N-vinyl-caprolactam, N-vinyl-N-alkylcarboxamides or N-vinylcarboxamides, such as N-vinylacetamide, N-vinyl-N-methylformamide, and N-vinyl-N-methylacetamide, or vinyl ethers, examples being methyl vinyl ether, ethyl vinyl ether, n-propyl vinyl ether, isopropyl vinyl ether, n-butyl vinyl ether, sec-butyl vinyl ether, isobutyl vinyl ether, tert-butyl vinyl ether, and 4-hydroxybutyl vinyl ether, and also mixtures thereof.

Compounds having at least two radically polymerizable C═C double bonds: these include more particularly the diesters and polyesters of the aforementioned α,β-ethylenically unsaturated monocarboxylic and/or dicarboxylic acids with diols or polyols. Particularly preferred examples of (meth)acrylic esters of polyols are ethylene glycol diacrylate, 1,2-propanediol diacrylate, 1,3-propanediol diacrylate, 1,4-butanediol diacrylate, 1,3-butanediol diacrylate, 1,5-pentanediol diacrylate, 1,6-hexanediol diacrylate, 1,8-octanediol diacrylate, neopentyl glycol diacrylate, 1,1-, 1,2-, 1,3-, and 1,4-cyclohexanedimethanol diacrylate, 1,2-, 1,3-, or 1,4-cyclohexanediol diacrylate, trimethylolpropane triacrylate, ditrimethylolpropane penta- or hexaacrylate, pentaerythritol tri- or tetraacrylate, glycerol di- or triacrylate, and also di- and polyacrylates of sugar alcohols, such as, for example, sorbitol, mannitol, diglycerol, threitol, erythritol, adonitol (ribitol), arabitol (lyxitol), xylitol, dulcitol (galactitol), maltitol, or isomalt.

Also preferred are the esters of alkoxylated polyols, with α,β-ethylenically unsaturated mono- and/or dicarboxylic acids, such as, for example, the polyacrylates or polymethacrylates of alkoxylated trimethylolpropane, glycerol, or pentaerythritol.

Preferred (meth)acrylates are those of compounds of the formulae (IVa) to (IVd),

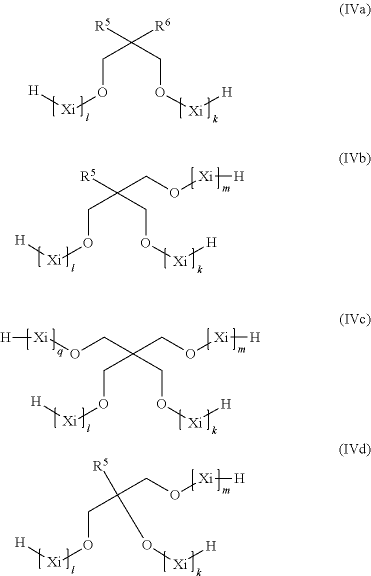

in which

R⁵ and R⁶ independently of one another are hydrogen or are C₁-C₁₈ alkyl which is optionally substituted by aryl, alkyl, aryloxy, alkyloxy, heteroatoms and/or heterocycles,

k, l, m, and q independently of one another are each an integer from 1 to 10, preferably 1 to 5, and more preferably 1 to 3, and

each Xᵢ for i=1 to k, 1 to l, 1 to m, and 1 to q may be selected independently of one another from the group —CH₂—CH₂—O—, —CH₂—CH(CH₃)—O—, —CH(CH₃)—CH₂—O—, —CH₂—C(CH₃)₂—O—, —C(CH₃)₂—CH₂—O—, —CH₂—CHVin-O—, —CHVin-CH₂—O—, —CH₂—CHPh-O—, and —CHPh-CH₂—O—, preferably from the group —CH₂—CH₂—O—, —CH₂—CH(CH₃)—O—, and —CH(CH₃)—CH₂—O—, and more preferably —CH₂—CH₂—O—,

where Ph is phenyl and Vin is vinyl.

In these compounds, C₁-C₁₈ alkyl optionally substituted by aryl, alkyl, aryloxy, alkoxy, heteroatoms and/or heterocycles means for example methyl, ethyl, propyl, isopropyl, n-butyl, sec-butyl, tert-butyl, pentyl, hexyl, heptyl, octyl, 2-ethylhexyl, 2,4,4-trimethylpentyl, decyl, dodecyl, tetradecyl, heptadecyl, octadecyl, 1,1-dimethylpropyl, 1,1-dimethylbutyl, 1,1,3,3-tetramethylbutyl, preferably methyl, ethyl, or n-propyl, very preferably methyl or ethyl.

With particular preference these are (meth)acrylates of singularly to vigintuply and very preferably triply to decuply ethoxylated, propoxylated, or mixedly ethoxylated and propoxylated, and more particularly exclusively ethoxylated, glycerol, trimethylolpropane, trimethylolethane, or pentaerythritol.

With very particular preference trimethylolpropane triacrylate, pentaerythritol tetraacrylate, and acrylates of singularly to vigintuply alkoxylated, more preferably ethoxylated, trimethylolpropane, glycerol, or pentaerythritol.

Also suitable are the esters of alicyclic diols, such as cyclohexanediol di(meth)acrylate and bis(hydroxymethyl)cyclohexane di(meth)acrylate. Other suitable reactive diluents are trimethylolpropane monoformal acrylate, glycerol formal acrylate, 4-tetrahydropyranyl acrylate, 2-tetrahydropyranyl methacrylate, and tetrahydrofurfuryl acrylate.

The stated reactive diluents may optionally be modified by addition of small amounts of primary or secondary amines.

In that case the reactive diluent is admixed with 0.1-8 wt %, preferably 0.5-6, and more preferably 1 to 6 wt % of compounds having a primary or secondary amino groups.

Examples include primary monoamines such as C₁-C₂₀ alkylamines, more particularly n-butylamine, n-hexylamine, 2-ethylhexylamine, octadecylamine, and cycloaliphatic amines such as cyclopentylamine or cyclohexylamine.

Secondary monoamines include, for example, those such as di-C₁-C₂₀ alkylamines, more particularly diethylamine, di-n-butylamine, di-n-hexylamine, and diisopropylamine.

Compounds having primary or secondary amino groups and at least one hydroxyl group include alkanolamines, examples being mono- or diethanolamine, aminoethoxyethanol, 2-aminopropan-1-ol, and diisopropanolamine.

One preferred embodiment of the present invention is do without low molecular mass reactive diluents, i.e., to use them only in amounts of not more than 5 wt %, more preferably in amounts of not more than 1 wt %.

By “low molecular mass reactive diluents” in this context are meant compounds having one or two radically polymerizable C═C double bonds and a molecular weight of not more than 500 g/mol.

Where the dispersions of the invention are cured not with electron beams but instead by means of UV radiation, it is preferable for the preparations of the invention to include at least one photoinitiator which is able to initiate the polymerization of ethylenically unsaturated double bonds.

Photoinitiators may be, for example, photoinitiators known to the skilled person, examples being those specified in “Advances in Polymer Science”, Volume 14, Springer Berlin 1974 or in K. K. Dietliker, Chemistry and Technology of UV and EB Formulation for Coatings, Inks and Paints, Volume 3; Photoinitiators for Free Radical and Cationic Polymerization, P. K. T. Oldring (Eds), SITA Technology Ltd, London.

Suitability is possessed, for example, by mono- or bisacylphosphine oxides, as described for example in EP-A 7 508, EP-A 57 474, DE-A 196 18 720, EP-A 495 751 or EP-A 615 980, examples being 2,4,6-trimethylbenzoyldiphenylphosphine oxide (Lucirin® TPO from BASF AG), ethyl 2,4,6-trimethylbenzoylphenylphosphinate (Lucirin® TPO L from BASF AG), bis(2,4,6-trimethylbenzoyl)phenylphosphine oxide (Irgacure® 819 from BASF SE, formerly Ciba Spezialitätenchemie), benzophenones, hydroxyacetophenones, phenylglyoxylic acid and its derivatives, or mixtures of these photoinitiators. Examples that may be mentioned include benzophenone, acetophenone, acetonaphthoquinone, methyl ethyl ketone, valerophenone, hexanophenone, α-phenylbutyrophenone, p-morpholinopropiophenone, dibenzosuberone, 4-morpholinobenzophenone, 4-morpholinodeoxybenzoin, p-diacetylbenzene, 4-aminobenzophenone, 4′-methoxyacetophenone, β-methylanthraquinone, tert-butylanthraquinone, anthraquinonecarboxylic esters, benzaldehyde, α-tetralone, 9-acetylphenanthrene, 2-acetylphenanthrene, 10-thioxanthenone, 3-acetylphenanthrene, 3-acetylindole, 9-fluorenone, 1-indanone, 1,3,4-triacetylbenzene, thioxanthen-9-one, xanthen-9-one, 2,4-dimethylthioxanthone, 2,4-diethylthioxanthone, 2,4-diisopropylthioxanthone, 2,4-dichlorothioxanthone, benzoin, benzoin isobutyl ether, chloroxanthenone, benzoin tetrahydropyranyl ether, benzoin methyl ether, benzoin ethyl ether, benzoin butyl ether, benzoin isopropyl ether, 7H-benzoin methyl ether, benz[de]anthracene-7-one, 1-naphthaldehyde, 4,4′-bis(dimethylamino)benzophenone, 4-phenylbenzophenone, 4-chlorobenzophenone, Michler's ketone, 1-acetonaphthone, 2-acetonaphthone, 1-benzoylcyclohexan-1-ol, 2-hydroxy-2,2-dimethylacetophenone, 2,2-dimethoxy-2-phenylacetophenone, 2,2-diethoxy-2-phenylacetophenone, 1,1-dichloroacetophenone, 1-hydroxyacetophenone, acetophenone dimethyl ketal, o-methoxybenzophenone, triphenylphosphine, tri-o-tolylphosphine, benz[a]anthracene-7,12-dione, 2,2-diethoxyacetophenone, benzil ketals, such as benzil dimethyl ketal, 2-methyl-1-[4-(methylthio)phenyl]-2-morpholinopropan-1-one, anthraquinones such as 2-methylanthraquinone, 2-ethylanthraquinone, 2-tert-butylanthraquinone, 1-chloroanthraquinone, and 2-amylanthraquinone, and 2,3-butanedione.

Also suitable are nonyellowing or low-yellowing photoinitiators of the phenylglyoxalic ester type, as described in DE-A 198 26 712, DE-A 199 13 353 or WO 98/33761.

Typical mixtures comprise, for example, 2-hydroxy-2-methyl-1-phenylpropan-2-one and 1-hydroxycyclohexyl phenyl ketone, bis(2,6-dimethoxybenzoyl)-2,4,4-trimethyl-pentylphosphine oxide and 2-hydroxy-2-methyl-1-phenylpropan-1-one, benzophenone and 1-hydroxycyclohexyl phenyl ketone, bis(2,6-dimethoxybenzoyl)-2,4,4-trimethyl-pentylphosphine oxide and 1-hydroxycyclohexyl phenyl ketone, 2,4,6-trimethylbenzoyldiphenylphosphine oxide and 2-hydroxy-2-methyl-1-phenylpropan-1-one, 2,4,6-trimethylbenzophenone and 4-methylbenzophenone or 2,4,6-trimethylbenzophenone, and 4-methylbenzophenone and 2,4,6-trimethylbenzoyldiphenylphosphine oxide.

Preference among these photoinitiators is given to 2,4,6-trimethylbenzoyldiphenylphosphine oxide, ethyl 2,4,6-trimethylbenzoylphenylphosphinate, bis(2,4,6-tri-methylbenzoyl)phenylphosphine oxide, benzophenone, 1-benzoylcyclohexan-1-ol, 2-hydroxy-2,2-dimethylacetophenone, and 2,2-dimethoxy-2-phenylacetophenone.

The dispersions of the invention comprise the photoinitiators preferably in an amount of 0.05 to 10 wt %, more preferably 0.1 to 8 wt %, in particular 0.2 to 5 wt %, based on the total amount of the components Aa) to Ag) and (C).

The dispersions of the invention preferably contain no thermal initiators.

Thermal initiators in the sense of the present invention are those which have a half-life at 60° C. of at least one hour. The half-life of a thermal initiator is the time after which half of the initial amount of the initiator has decomposed to form free radicals.

In accordance with the invention, thermal initiators are preferably absent, being present, therefore, in amounts of less than 0.1 wt %.

The dispersions according to the invention may comprise further customary coatings adjuvants, such as flow control agents, defoamers, UV absorbers, dyes, pigments and/or fillers.

Suitable fillers comprise silicates, e.g., silicates obtainable by hydrolysis of silicon tetrachloride, such as Aerosil® from Degussa, siliceous earth, talc, aluminum silicates, magnesium silicates, and calcium carbonates, etc. Suitable stabilizers comprise typical UV absorbers such as oxanilides, triazines, and benzotriazole (the latter obtainable as Tinuvin R grades from Ciba-Spezialitätenchemie, now BASF), and benzophenones. They can be used alone or together with suitable radical scavengers, examples being sterically hindered amines such as 2,2,6,6-tetramethylpiperidine, 2,6-di-tert-butylpiperidine or derivatives thereof, e.g., bis(2,2,6,6-tetramethyl-4-piperidyl) sebacate. Stabilizers are used usually in amounts of 0.1 to 5.0 wt %, based on the “solid” components comprised in the preparation.

### Component (E)

Polyamines having 2 or more primary and/or secondary amino groups can be used especially when the chain extension and/or crosslinking is to take place in the presence of water, since amines, generally speaking, react more quickly with isocyanates than do alcohols or water. This is frequently necessary when aqueous dispersions of crosslinked polyurethanes or polyurethanes with high molar weight are desired. In such cases the procedure adopted is to prepare the prepolymers having isocyanate groups, to disperse them rapidly in water, and then, by adding compounds having two or more isocyanate-reactive amino groups, to subject them to chain extension or crosslinking.

Amines suitable for this purpose are generally polyfunctional amines from the molar weight range from 32 to 500 g/mol, preferably from 60 to 300 g/mol, which contain at least two primary, two secondary, or one primary and one secondary amino group. Examples thereof are diamines such as diaminoethane, diaminopropanes, diaminobutanes, diaminohexanes, piperazine, 2,5-dimethylpiperazine, amino-3-aminomethyl-3,5,5-trimethylcyclohexane (isophoronediamine, IPDA), 4,4′-diaminodicyclohexylmethane, 1,4-diaminocyclohexane, aminoethylethanolamine, hydrazine, hydrazine hydrate, or triamines such as diethylenetriamine or 1,8-diamino-4-aminomethyloctane, or higher amines such as triethylenetetramine, tetraethylenepentamine, or polymer amines such as polyethyleneamines, hydrogenated polyacrylonitriles, or at least partly hydrolyzed poly-N-vinylformamides, in each case with a molar weight of up to 2000, preferably up to 1000 g/mol.

The amines can also be used in blocked form, as for example in the form of the corresponding ketimines (cf., e.g., CA-1 129 128), ketazines (cf., e.g., U.S. Pat. No. 4,269,748), or amine salts (see U.S. Pat. No. 4,292,226). Oxazolidines as well, as used for example in U.S. Pat. No. 4,192,937, represent capped polyamines which can be used for preparing the polyurethanes for the chain extension of the prepolymers. When capped polyamines of these kinds are used, they are generally mixed with the prepolymers in the absence of water, and this mixture is then mixed with the dispersion water, or with part of the dispersion water, so that the corresponding polyamines are released hydrolytically.

Preference is given to using mixtures of di- and triamines, more preferably mixtures of isophoronediamine and diethylenetriamine.

The fraction of polyamines (E) in the coating materials of the invention may be up to 10, preferably up to 8 mol %, and more preferably up to 5 mol %, based on the total amount of (meth)acrylate groups.

The solids content of the aqueous dispersions of the invention is preferably in a range from about 5 to 70, preferably 20 to 60 wt %, more preferably 30 to 50 wt %.

Preferred polyurethanes (A) are those in which the isocyanate groups in the compounds of component Aa) and, if present, Ag) have undergone reaction to an extent of
20 to 99 mol %, preferably 40 to 90 mol %, more preferably 55-82 mol % with groups that are reactive toward isocyanate groups, present in at least one compound of component Ab),
0 to 50 mol %, preferably 5 to 40 mol %, more preferably 10-30 mol % with groups that are reactive toward isocyanate groups, and are present in at least one compound of component Ac),
1 to 25 mol %, preferably 5 to 20 mol %, more preferably 8 to 15 mol %, with toward isocyanate groups present in at least one compound of component Ad),
0 to 5 mol %, preferably 0 to 2 mol %, more preferably 0 mol % with toward isocyanate groups present in at least one compound of component Ad).

The figures are based on molar equivalents of a functional group.

Particularly preferred dispersions are those which, per kg of polyurethane (A), based on the sum total of components Aa) to Ad) and Ae) to Ag), have at least 0.4 mol, preferably at least 0.45 mol/kg, of neutralized or free acid groups from Ad).

In one preferred embodiment the average diameter (z-average) of the particles of the polyurethane (A), measured at 25° C. by dynamic light scattering with the Malvern® Zetasizer 1000, in the aqueous dispersion does not exceed 40 nm, preferably 30 nm, and more preferably 25 nm.

Preferred polyurethanes (B) are those in which the isocyanate groups in the compounds of component Ba) and, if present, Bg) have undergone reaction to an extent of
20 to 99 mol %, preferably 40 to 90 mol %, more preferably 55-82 mol % with groups that are reactive toward isocyanate groups, present in at least one compound of component Bb),
0 to 50 mol %, preferably 5 to 40 mol %, more preferably 10-30 mol % with groups that are reactive toward isocyanate groups, and are present in at least one compound of component Bc),
1 to 25 mol %, preferably 5 to 20 mol %, more preferably 8 to 15 mol %, with toward isocyanate groups present in at least one compound of component Bd),
0 to 5 mol %, preferably 0 to 2 mol %, more preferably 0 mol % with toward isocyanate groups present in at least one compound of component Bd).

The figures are based on molar equivalents of a functional group.

Particularly preferred dispersions are those which, per kg of polyurethane (B), based on the sum total of components Ba) to Bd) and Be) to Bg), have at least 0.25 mol/kg, preferably at least 0.3 mol/kg, of neutralized or free acid groups from Bd).

The average diameter (z-average) of the particles of polyurethane (B), as measured at 25° C. by dynamic light scattering with the Malvern® Zetasizer 1000, has a minor role in accordance with the invention. One preferred embodiment is to use particles of the polyurethane (B) having an average diameter of at least 100, preferably at least 150, and very preferably at least 200 nm.

In one particularly preferred embodiment of the present invention, the ratio of the average diameter (z-average) of the particles of the polyurethane (A) to that of the particles of the polyurethane (B) is from 1:2 to 1:5, preferably 1:2 to 1.4, and more preferably 1:2 to 1:3.

As a result of the presence of neutralized or free acid groups it is possible with preference to do without the use of organic solvents, more particularly of N-methylpyrrolidone, for dispersing, and so the VOC content of the dispersions of the invention is not increased by these organic solvents.

In accordance with the invention the mixing ratio of polyurethane (A) and polyurethane (B) is selected such that the mixture thereof after drying and before UV curing has a pendulum damping to DIN 53157 of at least 20, preferably at least 30, swings.

In another, alternative, equally preferred embodiment, the mixing ratio of polyurethane (A) and polyurethane (B) is selected such that it is from 20:80 to 80:20, based on the weight, more preferably from 30:70 to 70:30, and very preferably from 40:60 to 60:40.

In one preferred embodiment the coating materials of the invention comprise a mixture of the polyurethanes (A) and (B).

It is, however, also possible to apply the polyurethanes (A) and (B) separately from one another to the substrate, preferably first polyurethane (A) and then polyurethane (B).

The dispersions of the invention are particularly suitable as coating material or in coating materials, more preferably for coating substrates such as wood, paper, textile, leather, nonwoven, plastics surfaces, glass, ceramic, mineral building materials, such as cement moldings and fiber-cement slabs, and, in particular, for coating metals or coated metals.

The dispersions of the invention can be used with particular advantage for coating wood and woodbase materials and wood-containing substrates, such as fiberboard. Also conceivable would be the coating of substrates containing cellulose fiber, such as paper, paperboard, or cardboard, for example. With very particular preference the dispersions are suitable for the coating of oak, spruce, pine, beech, maple, walnut, macoré, chestnut, plane, robinia, ash, birch, stone pine, and elm, and also cork.

The dispersions of the invention, after curing by high-energy radiation, advantageously form films having good performance properties, more particularly good hardness with sufficient elasticity and at the same time good grain highlighting.

The substrates are coated in accordance with customary methods that are known to the skilled person, involving the application of at least one dispersion of the invention to the substrate that is to be coated, in the desired thickness, and removal of the volatile constituents of the dispersions, by means of drying and/or evaporation at ambient temperature or elevated temperature up to 60° C., for example.

This process can be repeated one or more times if desired. Application to the substrate may take place in a known way, e.g., by spraying, troweling, knifecoating, brushing, rolling, roller-coating or pouring. The coating thickness is generally situated within a range from about 3 to 1000 g/m² and preferably 10 to 200 g/m².

Optionally, if two or more films of the coating material are applied one on top of another, a radiation cure may take place after each coating operation.

It is, however, also possible to apply the polyurethanes (A) and (B) separately from one another to the substrate, preferably first polyurethane (A) and then polyurethane (B). In that case, after application of the first coating material, it is possible first to carry out drying and optionally also adhering, preferably only drying. In the latter case the radiation cure takes place at the end, after all of the layers have been applied.

If separate application of the polyurethanes (A) and (B) is selected, then they are each provided separately from one another in dispersion form with admixture of the constituents (C), (D) and/or (E), if desired.

Radiation curing is accomplished by exposure to high-energy radiation, i.e., UV radiation or daylight, preferably light with a wavelength of 250 to 600 nm, or by irradiation with high-energy electrons (electron beams; 150 to 300 keV). Examples of radiation sources used include high-pressure mercury vapor lamps, lasers, pulsed lamps (flash light), halogen lamps or excimer emitters. The radiation dose normally sufficient for crosslinking in the case of UV curing is situated within the range from 80 to 3000 mJ/cm².

Irradiation may also, optionally, be carried out in the absence of oxygen, e.g., under an inert gas atmosphere. Suitable inert gases include, preferably, nitrogen, noble gases, carbon dioxide or combustion gases. Irradiation may also take place with the coating material being covered by transparent media. Transparent media are, for example, polymeric films, glass or liquids, e.g., water. Particular preference is given to irradiation in the manner as is described in DE-A1 199 57 900.

In one preferred process, curing takes place continuously, by passing the substrate treated with the preparation of the invention at constant speed past a radiation source. For this it is necessary for the cure rate of the preparation of the invention to be sufficiently high.

This varied course of curing over time can be exploited in particular when the coating of the article is followed by a further processing step in which the film surface comes into direct contact with another article or is worked on mechanically.

The advantage of the dispersions of the invention is that the coated articles can be further processed immediately after the radiation cure, since the surface is no longer tacky. Moreover, the dried film is still so flexible and extensible that the article can still be deformed without the film flaking or rupturing.

The invention is illustrated by means of the following nonlimiting examples.

### EXAMPLES

### Example 1

### Preparing a Polyurethane Acrylate Dispersion (A)

A stirred tank was charged with 78 parts of hydroxyethyl acrylate, 37 parts of neopentyl glycol, 47 parts of dimethylolpropionic acid, 572 parts of an acrylated polyisocyanate (Laromer® LR 9000, BASF SE), 0.4 part of 2,6 di-tert-butyl-p-cresol, 0.5 part of hydroquinone monomethyl ether, and 184 parts of acetone, and 0.5 part of dibutyltin dilaurate was added at room temperature. The batch was heated to 80° C. and left to react at 80° C. for 6 hours. It was thereafter diluted with 130 parts of acetone. The NCO value was 0.24%. 184 parts of 10% strength aqueous sodium hydroxide solution were added, and 1400 parts of water were added dropwise thereafter over 45 minutes. The acetone was subsequently removed by distillation under reduced pressure. The solids content was adjusted to 30% by addition of water. The viscosity was 320 mPas and the particle size of the translucent dispersion was 21 nm.

### Example 2

### Preparing a Polyurethane Acrylate Dispersion (A)

A stirred tank was charged with 113 parts of hydroxyethyl acrylate, 69 parts of dimethylolpropionic acid, 553 parts of an acrylated polyisocyanate (Laromer® LR 9000, BASF SE), 0.4 part of 2,6 di-tert-butyl-p-cresol, 0.5 part of hydroquinone monomethyl ether, and 184 parts of acetone, and 0.5 part of Borchi® Kat 24 (bismuth carboxylate) was added at room temperature. The batch was heated to 80° C. and left to react at 80° C. for 6 hours. It was thereafter diluted with 130 parts of acetone. The NCO value was 0.15%. 184 parts of 10% strength aqueous sodium hydroxide solution were added, and 1200 parts of water were added dropwise thereafter over 45 minutes. The acetone was subsequently removed by distillation under reduced pressure. The solids content was 37%. The viscosity is 6200 mPas and the particle size of the translucent solution was below 20 nm.

### Example 3

### Preparing a Polyurethane Acrylate Dispersion (B)

The procedure of example 2 was repeated, but with the 553 parts of Laromer® LR 9000 replaced by a mixture of 290 parts of Laromer® LR9000 and 260 parts of an isocyanurate of isophorone diisocyanate (Vestanat® T1890 from Evonik).

The viscosity of the dispersion was 580 mPas and the particle size was smaller than 20 nm.

### Example 4

### Preparing a Polyurethane Acrylate Dispersion (B)

A stirred tank was charged with 50 parts of cyclohexanedimethanol, 39 parts of 1,4-butanediol, 45 parts of neopentyl glycol, 28 parts of dimethylolpropionic acid, 183 parts of bisphenol A-diglycidyl ether diacrylate, 0.4 part of 2,6-di-tert-butyl-p-cresol, 0.2 part of hydroquinone monomethyl ether, and 184 parts of acetone, and at room temperature 0.5 part of Borchi® Kat 24 (bismuth carboxylate, OMG Borchers GmbH, Langenfeld) was added. The batch was heated to 60° C. and then 388 parts of isophorone diisocyanate were added. After a reaction time of 4 hours at 80° C., on attainment of an NCO value of 0.8%, the temperature of the reaction mixture is lowered by addition of 450 parts of acetone, followed by neutralization with 63 parts of 10% strength aqueous sodium hydroxide solution. Subsequently 1200 parts of water were added dropwise over 45 minutes. The acetone was then removed by distillation under reduced pressure. The solids content was adjusted to 38% by addition of water. The viscosity was 145 mPas and the particle size of the dispersion was 480 nm.

### Example 4

### Preparing a Polyurethane Acrylate Dispersion (B)

A stirred tank was charged with 50 parts of cyclohexanedimethanol, 39 parts of 1,4-butanediol, 45 parts of neopentyl glycol, 28 parts of dimethylolpropionic acid, 183 parts of bisphenol A-diglycidyl ether diacrylate, 0.4 part of 2,6-di-tert-butyl-p-cresol, 0.2 part of hydroquinone monomethyl ether, and 184 parts of acetone, and at room temperature 0.5 part of Borchi® Kat 24 (bismuth carboxylate, OMG Borchers GmbH, Langenfeld) was added. The batch was heated to 60° C. and then 388 parts of isophorone diisocyanate were added. After a reaction time of 4 hours at 80° C., on attainment of an NCO value of 0.8%, the temperature of the reaction mixture is lowered by addition of 450 parts of acetone, followed by neutralization with 63 parts of 10% strength aqueous sodium hydroxide solution. Subsequently 1200 parts of water were added dropwise over 45 minutes. The acetone was then removed by distillation under reduced pressure. The solids content was adjusted to 38% by addition of water. The viscosity was 145 mPas and the particle size of the dispersion was 480 nm.

### Example 5

### Preparing a Polyurethane Acrylate Dispersion (B)

A stirred tank was charged with 93 parts of cyclohexanedimethanol, 67 parts of neopentyl glycol, 29 parts of dimethylolpropionic acid, 96 parts of a polyester based on adipic acid and neopentyl glycol, with a hydroxyl number of 210 mg KOH/g, 0.4 part of 2,6-di-tert-butyl-p-cresol, 0.2 part of hydroquinone monomethyl ether, and 184 parts of acetone, and at room temperature 0.5 part of Borchi® Kat 24 (bismuth carboxylate, OMG Borchers GmbH, Langenfeld) was added. The batch was heated to 60° C. and then 407 parts of isophorone diisocyanate were added. After a reaction time of 4 hours at 80° C., on attainment of an NCO value of 0.2%, the temperature of the reaction mixture is lowered by addition of 400 parts of acetone, followed by neutralization with 84 parts of 10% strength aqueous sodium hydroxide solution. Subsequently 1500 parts of water were added dropwise over 45 minutes. The acetone was then removed by distillation under reduced pressure. The solids content was adjusted to 33% by addition of water. The viscosity was 200 mPas and the particle size of the dispersion was 80 nm.

### Example 6

### Preparing a Polyurethane Acrylate Dispersion (B)

A stirred tank was charged with 86 parts of cyclohexanedimethanol, 62 parts of neopentyl glycol, 27 parts of dimethylolpropionic acid, 179 parts of bisphenol A diglycidyl ether diacrylate, 0.4 part of 2,6-di-tert-butyl-p-cresol, 0.2 part of hydroquinone monomethyl ether, and 184 parts of acetone, and at room temperature 0.5 part of Borchi® Kat 24 (bismuth carboxylate, OMG Borchers GmbH, Langenfeld) was added. The batch was heated to 60° C. and then 379 parts of isophorone diisocyanate were added. After a reaction time of 4 hours at 80° C., on attainment of an NCO value of 0.7%, the temperature of the reaction mixture is lowered by addition of 400 parts of acetone, followed by neutralization with 70 parts of 10% strength aqueous sodium hydroxide solution. Subsequently 1400 parts of water were added dropwise over 45 minutes. The acetone was then removed by distillation under reduced pressure. The solids content was adjusted to 35% by addition of water. The viscosity was 150 mPas and the particle size of the dispersion was 124 nm.

### Summary of the Physical Parameters

| | Glass transition temperature | Particle size |
|---|---|---|
| Example | T_{g}, onset [° C.] | Dₕ, [nm] |
| 1 | −10 | 22 |
| 2 | −15 | 25 |
| 3 | +17 | 34 |
| 4 | +98 | 480 |
| 5 | +74 | 80 |
| 6 | +100 | 124 |

### Performance Testing

### Production of Films

### Application Example 1

The dispersions or solutions from examples 2 and 3 were mixed with one another in the stated mixing ratio, admixed with 4 wt % of Irgacure® 500 photoinitiator (BASF SE, formerly Ciba Spezialitätenchemie), and applied to a pre-sanded wood substrate, using a 200 μm four-way bar applicator.

The coated substrates were flashed off at room temperature for 15 minutes and in a forced-air oven at 60° C. for 30 minutes, and irradiated in an IST UV unit, on a conveyor belt at 10 m/min, in two passes, with two mercury UV lamps (120 W/cm). They were then resanded (160 grade) and thereafter coated again (as above), dried, and again UV-cured as above.

### Blends of Example 2 and of Example 3

| | Blend of example 2 with example 3 | | | | | |
|---|---|---|---|---|---|---|
| | 100:0 | 80:20 | 60:40 | 40:60 | 20:80 | 0:100 |
| Grain highlighting, | 1 | 1 | 2 | 2 | 3 | 3.5 |
| including beech | | | | | | |
| (pale)[1] | | | | | | |
| Grain highlighting | 1 | 1 | 1.5 | 2 | 2.5 | 3 |
| on walnut[1] | | | | | | |
| Pendulum damping | sticks = not | 0 | 7 | 24 | 63 | 66 |
| before UV | measurable | | | | | |
| exposure [2] | | | | | | |
| Coffee [3] 4% 16 h | 3 | 3 | 4 | 5 | n.d. | 4 |
| Coffee 4% 6 h | 3 | 3 | 4 | 5 | n.d. | 5 |
| Coffee 4% 1 h | 4 | 4 | 5 | 5 | n.d. | 5 |
| Ethanol 48% 1 h | 5 | 5 | 5 | 5 | n.d. | 5 |
| Ethanol 48% 6 h | 5 | 5 | 5 | 5 | n.d. | 4 |
| Water (dist.) 48 h | 5 | 5 | 5 | 5 | n.d. | 4 |

[1]Assessment visually by rating, rating 1 = best result, rating 4 = worst result. The benchmark was 100% UV formulation based on an amine-modified polyester acrylate (Laromer ® PO 84F, BASF SE) with good grain highlighting: rating of 1).
[2] Pendulum hardness by König method, DIN 53157 (swings), measurement conditions: film thickness at least 200 μm, relative humidity 40-60%, and temperature 20-24° C.
[3] Chemicals resistance according to DIN EN 12720. The following were determined: water (24 h), coffee (16 h, 6 h, 1 h), ethanol in 48% form in water (6 h, 1 h). Rating 5: best result, rating 1 = worst result.

### Application Example 2

Blends were prepared of the dispersions from example 1 and example 4, in the blending ratios stated.

| | Grain highlighting on | Pendulum hardness |
|---|---|---|
| Blending ratio | beech wood floor | before UV curing |
| 100:0 | 1 | not measurable |
| 90:10 | 1.5 | not measurable |
| 80:20 | 1.5 | 17 |
| 70:30 | 2 | 34 |
| 50:50 | 5 | n.d. |

### Application Example 3

Blends were prepared of the dispersions from example 1 and example 6, in the blending ratios stated.

| | Grain highlighting on | Pendulum hardness |
|---|---|---|
| Blending ratio | beech wood floor | before UV curing |
| 100:0 | 1 | not measurable |
| 90:10 | 1.5 | not measurable |
| 80:20 | 1.5 | 17 |
| 70:30 | 2 | 41 |
| 50:50 | 5 | n.d. |

### Application Example 4

Blends were prepared of the dispersions from example 1 and example 5, in the blending ratios stated.

| | Grain highlighting on | Pendulum hardness |
|---|---|---|
| Blending ratio | beech wood floor | before UV curing |
| 100:0 | 1 | not measurable |
| 70:30 | 1 | 17 |
| 65:35 | 2 | 30 |
| 60:40 | 2 | 37 |

1: A coating material comprising at least two radiation-curable polyurethanes (A) and (B) in dispersion in water, polyurethane (A) having been synthesized from
(Aa) an aliphatic di- or polyisocyanate,
(Ab) a compound having at least one group that is reactive toward isocyanate groups, and having at least one radically polymerizable C═C double bond,
(Ac) optionally a compound having at least two groups that are reactive toward isocyanate groups and are selected from hydroxyl, mercapto, and primary and/or secondary amino groups,
(Ad) a compound having at least one group that is reactive toward isocyanate groups, and having at least one acid group,
(Ae) a basic compound capable of full or partial neutralization of the acid groups of the compounds Ad),
(Af) optionally a compound different from Ab), Ad), and Ae) and having only one group that is reactive toward isocyanate groups,
(Ag) optionally a di- or polyisocyanate other than Aa), and the polyurethane (B) having been synthesized from
(Ba) a cycloaliphatic or aromatic di- or polyisocyanate,
(Bb) a compound having at least one group that is reactive toward isocyanate groups, and having at least one radically polymerizable C═C double bond,
(Bc) optionally a compound having at least two groups that are reactive toward isocyanate groups and are selected from hydroxyl, mercapto, and primary and/or secondary amino groups,
(Bd) a compound having at least one group that is reactive toward isocyanate groups, and having at least one acid group,
(Be) a basic compound capable of full or partial neutralization of the acid groups of the compounds Bd),
(Bf) optionally a compound different from Bb), Bd), and Be) and having only one group that is reactive toward isocyanate groups,
(Bg) optionally an aliphatic di- or polyisocyanate other than Ba),
(C) optionally further adjuvants selected from reactive diluents, photoinitiators, and customary coatings adjuvants,
(D) water, and
(E) optionally a di- and/or polyamine,
the polyurethane (B) on its own after drying over a period of 16 to 24 hours at a wet film thickness of 200 μm, a temperature of 20 to 24° C., and a relative humidity of 40% to 60%, and before UV curing, having a pendulum damping to DIN 53157 of at least 50 swings, and the mixing ratio of polyurethane (A) and polyurethane (B) being selected such that the mixture thereof after drying over a period of 16 to 24 hours at a wet film thickness of 200 μm, a temperature of 20 to 24° C., and a relative humidity of 40% to 60%, and before UV curing, has a pendulum damping to DIN 53157 of at least 5 swings.

2: The coating material according to claim 1, in which polyurethane (A) after drying and before curing has a glass transition temperature Tg (extrapolated on set temperature, T_{eig}), as determined by the DSC (Differential Scanning calorimetry) method in accordance with ASTM 3418/82 with a heating rate of 10° C./min, of less than 10° C.

3: The coating material according to claim 2, in which polyurethane (B) after drying and before curing has a glass transition temperature Tg (extrapolated onset temperature, T_{eig}), as determined by the DSC (Differential Scanning calorimetry) method in accordance with ASTM 3418/82 with a heating rate of 10° C./min, of more than 10° C.

4: The coating material according to claim 2, in which the mixing ratio of polyurethane (A) and polyurethane (B) is from 20:80 to 80:20, based on the weight.

5: The coating material according to claim 1, wherein component Aa) comprises an oligomer comprising isocyanurate, uretdione and/or allophanate groups and based on 1,6-hexamethylene diisocyanate.

6: The coating material according to claim 1, wherein component Aa) comprises a compound of the following formula 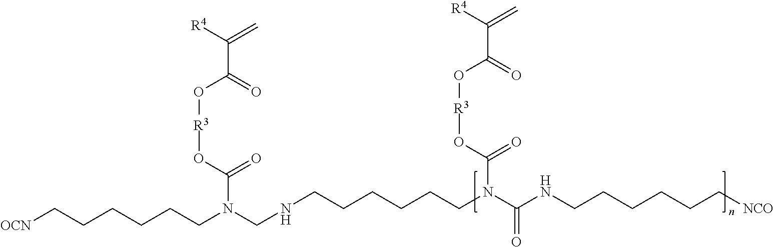
in which
R³ is a divalent aliphatic or cycloaliphatic radical having 2 to 12 carbon atoms,
R⁴ is hydrogen or methyl, and
n may adopt on average 0 or a positive number.

7: The coating material according to claim 1, wherein component Ba) comprises a cycloaliphatic di- or polyisocyanate.

8: The coating material according to claim 1, wherein component Ba) comprises isophorone diisocyanate, 4,4′- or 2,4′-di(isocyanatocyclohexyl)methane, or an isocyanurate thereof.

9: The coating material according to claim 1, wherein component Bc) is present and comprises a cycloaliphatic diol and/or an aliphatic diol in which the two hydroxyl groups are separated from one another by not more than four carbon atoms.

10: The coating material according to claim 1, wherein component Bc) is present and comprises a compound selected from the group consisting of ethylene glycol, 1,2-propanediol, 1,3-propanediol, 1,1-dimethylethane-1,2-diol, 2-butyl-2-ethyl-1,3-propanediol, 2-ethyl-1,3-propanediol, 2-methyl-1,3-propanediol, neopentyl glycol, 1,2-butanediol, 1,3-butanediol, 1,4-butanediol, bis(4-hydroxycyclohexane)isopropylidene, tetramethylcyclobutanediol, 1,2-cyclohexanediol, 1,3-cyclohexanediol, 1,4-cyclohexanediol, cyclooctanediol, norbornanediol, pinanediol, decalindiol, 2,2-bis(4-hydroxycyclohexyl)propane, 1,1-cyclohexanedimethanol, 1,2-cyclohexanedimethanol, 1,3-cyclohexanedimethanol, 1,4-cyclohexanedimethanol, 1,2-cyclohexanediol, 1,3-cyclohexanediol, and 1,4-cyclohexanediol.

11: The coating material according to claim 1, wherein component Ab) and/or Bb) are/is selected from 2-hydroxyethyl acrylate, 2-hydroxyethyl methacrylate, 2-hydroxypropyl acrylate, 2-hydroxypropyl methacrylate, 3-hydroxybutyl acrylate, 3-hydroxybutyl methacrylate, 4-hydroxybutyl acrylate, 4-hydroxybutyl methacrylate, 6-hydroxyhexyl acrylate, 6-hydroxyhexyl methacrylate, 3-hydroxy-2-ethylhexyl acrylate, 3-hydroxy-2-ethylhexyl methacrylate, trimethylolpropane mono- or diacrylate, pentaerythritol di- or triacrylate, and mixtures thereof.

12: The coating material according to claim 1, wherein components Ad) and Bd) are selected from the group consisting of dimethylolpropionic acid and dimethylolbutyric acid.

13: The coating material according to claim 1, wherein a ratio of the average diameter (z-average) of particles of the polyurethane (A) to that of particles of the polyurethane (B) is from 1:2 to 1:5.

14: A method for coating a substrate, comprising applying a coating material according to claim 1 to a substrate and subsequently drying and radiation-curing the coating material.

15: The method according to claim 14, wherein the substrate is selected from the group consisting of oak, spruce, pine, beech, maple, chestnut, plane, robinia, ash, birch, pine, elm, walnut, and macore.

16: A method for coating a substrate, comprising applying a coating material according claim 1, to coat wood, paper, textile, leather, nonwoven, plastics surface, glass, ceramic, mineral building material, metal, coated metal, paper, paperboard, or cardboard.

17: The coating material according to claim 1, wherein the polyurethane (B) on its own after drying over a period of 24 hours at a wet film thickness of 200 μm, a temperature of 20 to 24° C., and a relative humidity of 40% to 60%, and before UV curing, having a pendulum damping to DIN 53157 of at least 50 swings, and the mixing ratio of polyurethane (A) and polyurethane (B) being selected such that the mixture thereof after drying over a period of 24 hours at a wet film thickness of 200 μm, a temperature of 20 to 24° C., and a relative humidity of 40% to 60%, and before UV curing, has a pendulum damping to DIN 53157 of at least 20 swings.
